(19) United States
(12) Patent Application Publication
(10) Pub. No.: US 2016/0055741 A1
(43) Pub. Date: Feb. 25, 2016

(54) ELECTRONIC QUEUING AND NOTIFICATION SYSTEM

(71) Applicant: RICHPLAY INFORMATION CO., LTD., NEW TAIPEI CITY 22068 (TW)

(72) Inventors: CHI-HSIN LIANG, NEW TAIPEI CITY 24147 (TW); MING-HAN HUANG, TAIPEI CITY 108 (TW); HAN CHANG, NEW TAIPEI CITY 241 (TW); YI-HSIANG CHEN, NEW TAIPEI CITY 22068 (TW)

(21) Appl. No.: 14/821,934

(22) Filed: Aug. 10, 2015

(30) Foreign Application Priority Data
Aug. 20, 2014 (TW) 103128554

(51) Int. Cl. G08B 21/24; H04W 4/12

(52) U.S. Cl. CPC G08B 21/24; H04W 4/12

(57) ABSTRACT

The present invention relates to an electronic queuing and notification system, which comprises a queuing device and a plurality of mobile electronic devices. The queuing device comprises a control module, a processor, and a message submitting module. By using the present invention, patients, consumers, or people dealing with affairs in hospitals, stores, or government organizations will be notified. Those about to be called will receive notification messages via the mobile electronic devices linked with the registered contact data while drawing the number. Then they can set off for consulting, purchasing, or dealing with affairs. Thereby, the waiting time in the above places can be saved.

### FIELD OF THE INVENTION

The present invention relates generally to a notification system, and particularly to an electronic queuing and notification system that can notify automatically an individual having a queuing number of being about to be called in hospitals, stores, or government organizations for reducing wasting time in the above places.

### BACKGROUND OF THE INVENTION

Queuing for buying or seeing a doctor is a quite normal event in modern lives. After drawing a queuing number or registering, when the queuing device notifies the number one draws, it means it's his turn for the service described above. Nonetheless, the waiting period usually costs one a long and unpredictable wait.

Take hospitals for example. The outpatient departments of hospital are usually swarmed with patients. The main reason is that although registration can be done through the Internet or telephone presently, the waiting patients are normally numerous. Besides, the time for a doctor to diagnose varies. Once a waiting patient misses his queuing number, he may lose his right of receiving the medical service. Consequently, registered patients normally need to wait in the waiting room and pay attention all the time for avoiding missing his number. Nonetheless, this requires patients to wait for a long time in the waiting room, making the waiting room extremely crowded and increasing the risk of cross infection among patients. In addition, because patients need to wait in the waiting room, their time is wasted. If one leaves the waiting room temporarily during the waiting time, he usually might miss his number. Then he needs to re-check in to wait for filling the vacancy or cutting in the queue, or even to re-register. These all cause inconvenience and time-wasting for hospitals and patients.

Accordingly, how to improve the current medical queuing mechanism has become a subject of technology development.

According to the Taiwan Patent Number 1238338, an online inquiry system for medical queue is disclosed. The inquiry system collects the real-time queuing numbers of several hospitals and clinics. A user inquires the queuing number through the Internet and decides his own time of arrival for the medical service. Although this technology can save the waiting time for patients, they still need to inquire the updated called number from the websites of the hospitals spontaneously and continuously. This method causes users' arrangement of time inflexible. It is also relatively complicated and inconvenient in usage. Accordingly, there is still room of breakthrough for the present subject.

### SUMMARY

An objective of the present invention is to provide an electronic queuing and notification system, which notifies several subsequent patients when the notification device notifies a patient to enter the consulting room. Then patients need not to wait a long time in the waiting room after registration. Instead, they go to the hospital or clinic after receiving the notification. This ensures patients of no miss of calling. They need not to waste time waiting in the medical space with high possibility of infection. Hence, a protection mechanism is provided for patients' health.

Another objective of the present invention is to provide an electronic queuing and notification system, which submits notification messages automatically to the mobile electronic devices held by patients according to the contact data provided during registration. Thereby, no extra processing cost is required for hospitals. Patients need not to configure in their mobile device, either. Hence, no inconvenience is incurred.

A further objective of the present invention is to provide an electronic queuing and notification system. In addition the above medical institutions, the present invention is applicable to various occasions requiring queuing, such as lining up for buying in stores or dealing with affairs in places such as banks or government organizations.

In order to achieve the objectives as described above, the present invention discloses an electronic queuing and notification system, which comprises a queuing device and a plurality of mobile electronic devices. The queuing device comprises a control module, a processor, and a message submitting module. The processor receives a calling instruction provided by the control module. The calling instruction includes first registration serial number. The processor generates a plurality of notification message according to a plurality of second registration serial numbers collected by a data registration module for notifying a plurality of subsequent second registration serial numbers starting from the first registration serial number. The message submitting module submits the plurality of notifications to the plurality of mobile electronic devices, which are linked to the plurality of second registration serial numbers, respectively, according to contact data.

### BRIEF DESCRIPTION OF THE DRAWINGS

FIG. 1 shows a schematic diagram of spatial relationship according to a preferred embodiment of the present invention, used for illustrating the user at the near side and the observer at the remote side;

FIG. 2 shows a schematic diagram of device architecture according to a preferred embodiment of the present invention, used for illustrating the mechanism during normal usage;

FIG. 3 shows a schematic diagram of an example table of registration data according to a preferred embodiment of the present invention; and

FIG. 4 shows a schematic diagram of device architecture for the queuing device according to a preferred embodiment of the present invention, used for illustrating the disposition of the algorithm module.

### DETAILED DESCRIPTION

In order to make the structure and characteristics as well as the effectiveness of the present invention to be further understood and recognized, the detailed description of the present invention is provided as follows along with embodiments and accompanying figures.

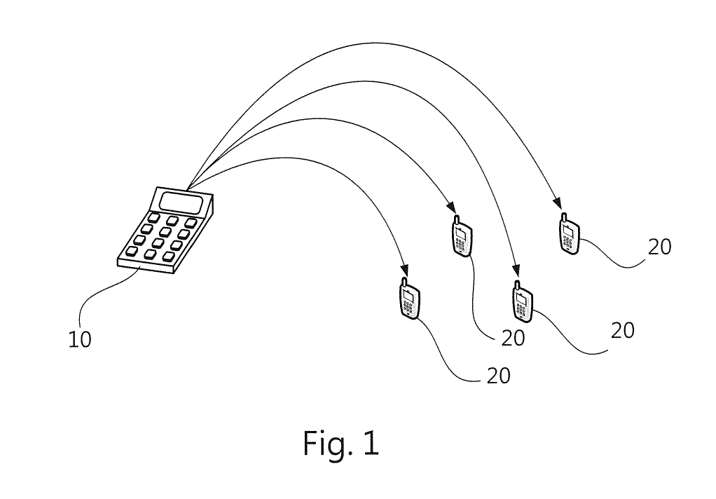

First, please refer to FIG. 1. In the electronic queuing and notification system according to the present invention, the hardware comprises a queuing devices 10 located at occasions such as hospitals, stores, government organizations and other similar places and mobile electronic devices 20 at users' side. The quelling device 10 can submit its generated notification messages to the mobile electronic devices 20 through the Internet or other communication methods according to the prior art.

The mobile electronic devices 20 as described above can be functional cellular phones or smartphones, which have the property of being linked to specific contact data such as telephone numbers. Take hospitals for example. The patients' telephone numbers are adopted as the contact method and are convenient for hospitals to transmit real-timely the notification messages to the patients as the users.

After patients or users have registered or drawn their queuing numbers, in order to avoid missing their number, they have to wait in the place. Then the place needs to provide sufficient spaces, seats, magazines. In hospitals, the concentrated waiting patients also face the risk of cross infection. Moreover, waiting is time-wasting. Thereby, how to reduce users' waiting time is the efficacy of the electronic queuing and notification system according to the present invention.

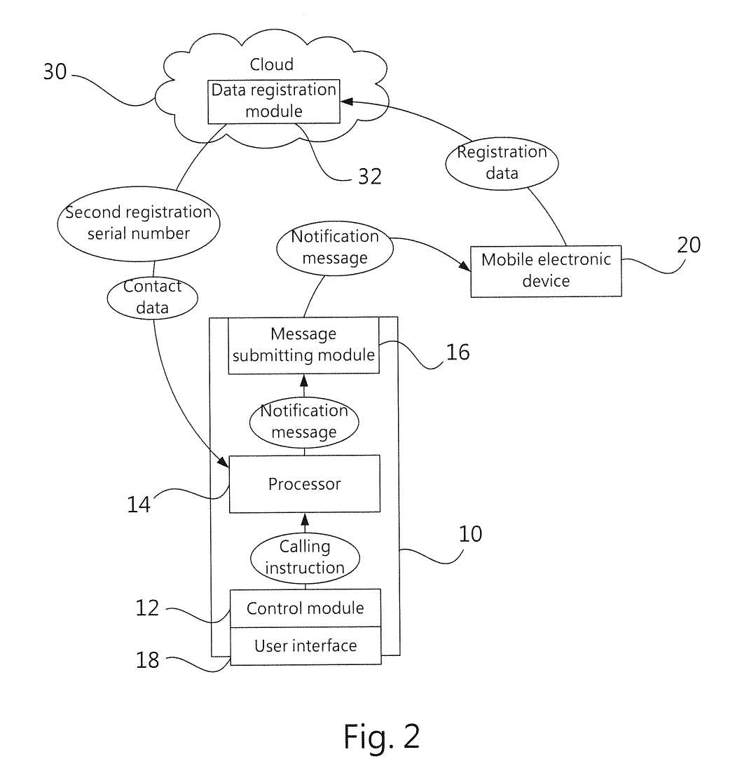

Please refer to FIG. 2. The structure of the queuing device 10 comprises a control module 12, a processor 14, and a message submitting module 16. The processor 14 is connected with the control module 12; and the message submitting module 16 is connected with the processor 14. In addition, the control module 12 includes a user interface 18 for users to operate the queuing device 10.

Take hospitals for example in the following description. The queuing device 10 is normally disposed in the consulting room of hospitals. Nurses operate the queuing device 10 via the user interface 18 according to the doctors' progress for notifying the current queuing number. Generally, the user interface 18 is button type. By pressing, a specific queuing number can be input or the queuing number will be added by one. Then the control module 12 will generate a calling instruction. After the processor 14 according to the present invention receives the calling instruction provided by the control module 12, a notification message will be generated in the operation according to the prior art fro notifying a patient to enter the consulting room. Nonetheless, the processor 14 according to the present invention will generate a plurality of notification messages according to a first registration serial number, namely, the current registration number to enter the consulting room, and according to a plurality of second serial numbers collected by a data registration module 32 located in a cloud 30. The second registration serial numbers are the registration numbers representing the queuing order produced by patients registering through the Internet or from the registration machine. The plurality of notification messages are used for notifying the plurality of second registration serial numbers counted from the one identical to the first registration serial number. For example, when a calling instruction to the registration number A is generated by the nurse by pressing the user interface 18 of the queuing device 10, the processor 14 will also generate the notification messages for A, A+1, A+2, A+3, etc. In addition to notifying the current patient to enter the consulting room, the several subsequent patients can be notified by simply executing the calling operation on the queuing device 10 by the nurse.

In addition to input data through the Internet or the registration machine, patients can use the mobile electronic devices 20 they carry to complete the registration process by using the methods such infrared, NFC, RFID, or QR code and leave their contact data while registering. Thereby, the second registration serial numbers collected by the data registration module 32 are linked to the patients' contact data, which correspond to the patients' mobile electronic devices 20. In other words, when a patient registers, his registration number, namely, the second registration serial number, is linked with his mobile phone number (the contact data). Hence, the hospital can contact the patient via the cellular phone, namely, the mobile electronic device. No matter the patient registers through the Internet, the registration machine, or other methods, the data registration module 32 in the cloud 30 can acquire the contact data of the patient's mobile electronic device 20. According to the acquired order, the second registration serial number is given.

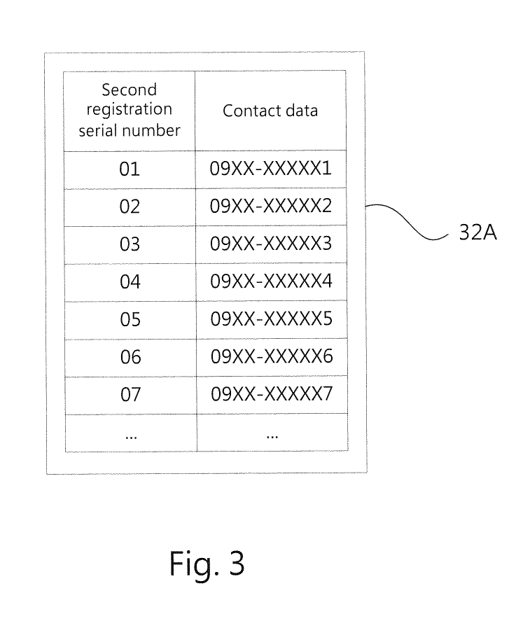

Please refer to FIG. 3, which shows the example registration data 32A in the data registration module 32, which provides the second registration serial number according to the order of registration. Each second registration serial number is linked with the contact data.

After the message submitting module 16 receives the notification messages generated by the processor 14, the notification messages are submitted to the mobile electronic devices 20. The mobile electronic devices 20 having received the notification messages are linked to the second registration serial numbers via the contact data. Thereby, the patient about to be called to enter the consulting room will get this message and can set off to the hospital.

The notification messages submitted by the message submitting module 16 are preferably short messages. Alternatively, automatic voice playback after dialing can be adopted as well. If a patients' mobile electronic device 20 is a smartphone, connection with the hospital can be done by an APP. The mode of receiving notification messages and the display method can be configured. The configuration can be done by further setting submission of the notification when the number to the current consulting registration number is reduced to a specific number.

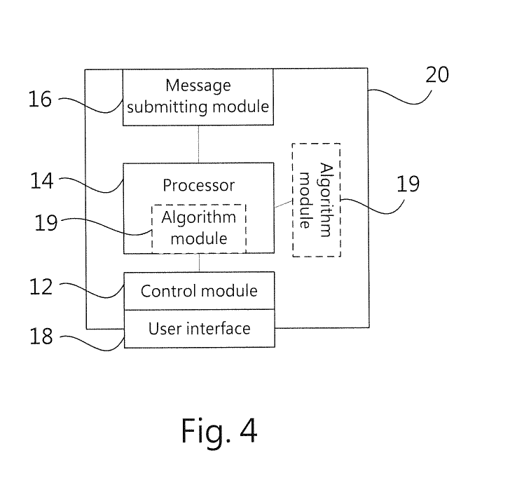

Please refer to FIG. 4, showing the queuing device 10, which further comprises an algorithm module 19, according to another preferred embodiment of the present invention. This algorithm module 19 is connected with the processor 14 or built in the processor 14. It can be used for analyzing the intervals of the calling instruction provided by the control module 12 for giving an estimated time. Because it is not easy for patients to estimate the time for their turn simply by knowing the intervals of the registration numbers, the present invention provides the estimated time as a reference for the patients to arrange their schedule according to the analysis of the algorithm module 19. By considering the difference in consulting times, the algorithm module 19 can further refer to parameters for individual doctors or parameters for individual medical departments and thus facilitating accuracy of the analyzed estimated time. If the queuing device 10 includes the algorithm module 19, the notification messages submitted by the message submitting module 16 will include the above estimated times, respectively. According to different second registration serial numbers, different estimated times are provided.

In addition the estimated times, the algorithm can also use the data users provided at registration and further generate customized notification messages. For example, when a user is a returning patient or a store member at a fixed period, the algorithm module 19 can calculate the required time to reach or recommend routes according to the patients' physical condition, past medical history, past traffic method, average speed, and the users' GPS location. The quelling device 10 can use a user's contact data as a medium for identification. The above personal information can be acquired through the Internet and linked with the data registration module or other database in the cloud. Thereby, in addition to providing more accurate information by the electronic queuing and notification system according to the present invention, the users can feel well served.

The preferred embodiment as described above is mainly focused on medical systems. Nonetheless, the present invention is not limited to the field. People can make use of the queuing device in the stores, banks, government organizations, or other similar occasions. After acquiring a queuing number and registering the relevant contact data, the mobile electronic devices can receive notification messages at the proper time. Thereby, substantial waiting time can be saved in the above places.

To sum up, the present invention discloses in detail an electronic queuing and notification system. Considering that after a general user registers or draws his number, if he do not wait in the place, he very possible will miss his turn. Thereby, the present notification system is developed. When the queuing device is pressed for notifying the next user, the other users about to be called will receive real-time notifications via their mobile electronic devices carried along with them. These users can move to the places after receiving the notifications; they need not to wait in the place and be limited. Thanks to its advantage in convenience, the present invention is undoubtedly a practical electronic queuing and notification system.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An electronic queuing and notification system, comprising a queuing device and a plurality of mobile electronic devices, characterized in that said queuing device comprises:
a control module;
a processor, receiving a calling instruction provided by said control module, said calling instruction comprising a first registration serial number, said processor generating a plurality of notification messages according to a plurality of second registration serial numbers collected by a data registration module for notifying some of said plurality of second registration serial numbers starting from the one identical to said first registration serial number; and
a message submitting module, submitting said plurality of notification messages to said plurality of mobile electronic devices, and said plurality of mobile electronic devices linked with said plurality of second registration serial numbers via contact data, respectively.

2. The electronic queuing and notification system of claim 1, wherein said queuing device further comprises a user interface connected with said control module.

3. The electronic queuing and notification system of claim 1, wherein said mobile electronic device is a functional cellular phone or a smartphone.

4. The electronic queuing and notification system of claim 1, wherein said data registration module is disposed in a cloud.

5. The electronic quelling and notification system of claim 1, wherein said plurality of notification messages include said first registration serial number and said second registration serial number linked with said mobile electronic device.

6. The electronic queuing and notification system of claim 1, wherein said data registration module acquires said contact data of said plurality of mobile electronic devices through the Internet, and gives said plurality of second registration serial numbers according to the order of acquirement.

7. The electronic queuing and notification system of claim 1, wherein said queuing device further comprises an algorithm module, connected with said processor or built in said processor, and analyzing the intervals of said calling instruction provided by said control module for giving an estimated time.

8. The electronic queuing and notification system of claim 7, wherein said plurality of notification messages include said estimated time, respectively.
